(19) United States
(12) Patent Application Publication
(10) Pub. No.: US 2011/0228541 A1
(43) Pub. Date: Sep. 22, 2011

(54) LUMINAIRE ASSEMBLY

(75) Inventor: Vincent Treanton, Lyon (FR)

(73) Assignee: KONINKLIJKE PHILIPS ELECTRONICS N.V., EINDHOVEN (NL)

(21) Appl. No.: 13/131,887

(22) PCT Filed: Nov. 27, 2009
(86) PCT No.: PCT/IB2009/055379

§ 371 Date: May 31, 2011

(30) Foreign Application Priority Data
Dec. 5, 2008 (EP) 08305889.1

(51) Int. Cl. F21V 7/22; F21V 15/01

(52) U.S. Cl. 362/296.01; 362/362

(57) ABSTRACT

A luminaire assembly (10; 20) comprising a support (11; 21) for receiving a light source (12; 22) a housing (13; 23) including a light exit portion (15; 25) disposed between a said light source (12; 22) and a target area to be illuminated and through which light from the said light source (12; 22) exits the housing (13; 23) a light intercepting element (161; 26) for preventing light from exiting the light exit portion (15; 25) along paths extending from the light exit portion (15; 25) in directions towards a region outside the target area.

A luminaire including a luminaire assembly and a light source is also described.

### FIELD OF THE INVENTION

The present invention relates to a luminaire assembly. Particularly, but not exclusively, the invention relates to a luminaire assembly for road lighting applications. The invention further relates to a luminaire comprising such a lighting assembly

### BACKGROUND OF THE INVENTION

An increasing problem in lighting applications, such as road lighting applications, is light emitted from a luminaire reaching a region outside of a desired target illumination area. Such a phenomenon is sometimes referred to as light trespass.

Various solutions for reducing light trespass from luminaires propose the use of louvers or shields to prevent light from a luminaire reaching an undesired area. A drawback of employing a louver is that light is prevented from reaching an undesired area at the expense of the performance of the luminaire since the blocked light is not used and is thus wasted. This can lead to a significant reduction in luminaire spacing which in turn results in an increase in the cost of the lighting installation.

U.S. Pat. No. 6,502,965 describes a luminaire in which an additional reflector is provided on the main back reflector of the luminaire between the primary reflector surface and a light source in order to redirect light incident on the additional reflector at a different angle than it would otherwise be reflected by the primary reflector surface.

### SUMMARY OF THE INVENTION

It would be advantageous to provide a luminaire assembly suitable for road lighting applications providing improvements in light trespass prevention.

To better address one or more of the foregoing concerns, in accordance with a first aspect of the invention there is provided a luminaire assembly comprising: a support for receiving a light source, a housing including a light exit portion disposed between a said light source and a target area to be illuminated and through which light from the said light source exits the housing; a light intercepting element for preventing light from exiting the light exit portion along paths extending through and/or from the light exit portion in directions towards a region outside the target area. Therefore the invention prevents a part of the light that would reach a region outside the area to be illuminated from exiting the luminaire, and allows re-directing this part of light for a better use.

In a particular embodiment the light intercepting element is arranged to redirect or deflect at least part of the light, according to said paths, in such a manner that said at least part of the light reaches the target area. The light may be redirected directly to the target area, or redirected to the target area via one or more intermediate paths.

In one embodiment the light intercepting element may be defined by a removable reflector element. Alternatively said light exit portion comprises a light exit element at least partly transparent to the light and the light intercepting element comprises a reflective layer provided on an inner and/or outer surface of the light exit element.

In a particular embodiment the light intercepting surface is adjustable to redirect light in a plurality of different directions.

The light exit portion may be an aperture in the housing or may be part of the housing made of material visible to the transmission of visible light. In an embodiment of the invention the light exit portion may be bowl shaped.

The light intercepting element may be disposed inside the luminaire housing or external to the luminaire housing such that it redirects light before it passes through the light exit portion of the housing or after it passes through the light exit portion, in each case the light being redirected away from the region outside the target area towards the target region area. The reflective layer may for example be provided on the inner surface or the outer surface of the light exit portion, the reflective layer being orientated towards incident light from the light source. Preferably, the light intercepting surface is disposed within the housing between the said light source and the light exit portion.

In some embodiments the luminaire assembly may comprise a back reflector arranged to redirect light travelling in a direction away from the light exit portion towards the light exit portion.

The intercepting element may be arranged to redirect at least part of the light from said paths towards the back reflector. The intercepting element may also or alternatively be arranged to redirect at least part of light from said paths to second paths extending in second directions towards the target area.

The luminaire may include a plurality of light intercepting elements. For example, the light exit portion may be provided with a plurality of light reflective layers disposed on different regions of the light exit portion.

A further aspect of the invention provides a luminaire for road lighting comprising a lighting assembly according to any of the embodiments hereinbefore described and a light source.

### BRIEF DESCRIPTION OF THE DRAWINGS

Embodiments of the invention will now be described, by way of example only, and with reference to the following drawings in which:

FIG. 1 is a partial schematic view of a luminaire according to a first embodiment of the invention;

FIG. 2 is a partial schematic view of the luminaire according to the first embodiment of the invention depicting paths of light flux through the luminaire;

FIG. 3 is a schematic view of the luminaire of FIG. 1 mounted on a lamp-post;

FIG. 4 is a partial schematic view of a luminaire according to a second embodiment of the invention;

FIG. 5 is a partial schematic view of the luminaire according to the second embodiment of the invention depicting paths of light flux through the luminaire;

FIG. 6 is a schematic view of the luminaire of FIG. 4 mounted on a lamp-post;

FIG. 7 is a perspective view of the lower housing of a luminaire according to an alternative embodiment of the invention; and

FIG. 8 is a graphical representation of light flux reaching a target area and an non-targeted area for a luminaire according to one of the embodiments of the invention compared to a luminaire of the prior art.

### DETAILED DESCRIPTION

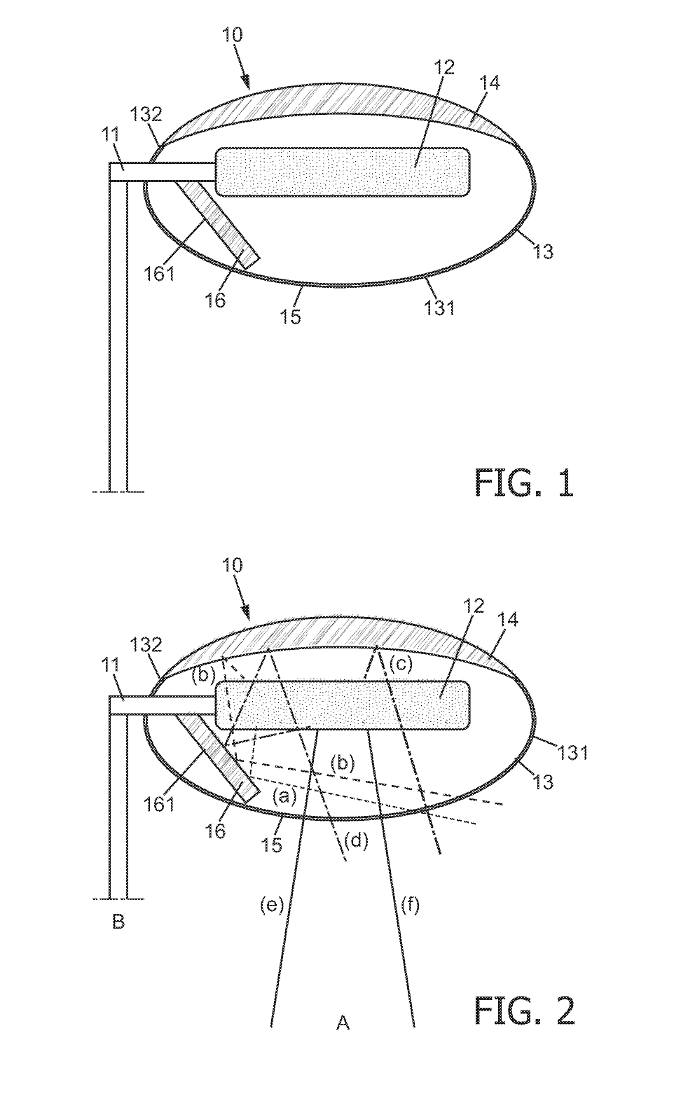

A road lighting luminaire according to a first embodiment of the invention will be described with reference to FIGS. 1 to 3. The road lighting luminaire 10 comprises a support 11 on which is mounted a light source 12 within an enclosure 13. Electrical power is provided to light source 12 via electrical connections (not shown) on the support 11. The light source 12 may be a High Intensity Discharge (HID) lamp, an LED type light source or any suitable light source for road lighting applications. The enclosure 13 is provided on its lower region 131 with a light exit portion 15 comprising a light transmission medium made of a material with visible light transmissive properties disposed between the light source 12 and the target region to be illuminated. The top side 132 of the enclosure 13 is provided with a reflection layer 14 on its inner surface to reflect light travelling from the light source 12 to the top side 132 of the enclosure 13 towards the light exit portion 15. Such a reflection layer is commonly referred to as a back reflector. In this embodiment, the light exit portion 15 is shaped in the form of a bowl. It will be appreciated that in alternative embodiments of the invention the light exit portion 15 may have different forms, such as for example a planar form. The luminaire 10 is also provided with a light intercepting element 16 in the form of a light reflector. Light redirecting reflector 16 is disposed within the housing 13 between the light source 12 and the light exit portion 15 in a rear region of the luminaire 10 in such a manner that it intercepts light travelling towards an area outside the target illumination region which is to be protected from light trespass. The front region of the luminaire is proximal to the area to be illuminated. At least the side 161 of light reflector 16 orientated to face towards the light source 12 is provided with a light reflecting surface. In this embodiment, the light reflector 16 is made of aluminium.

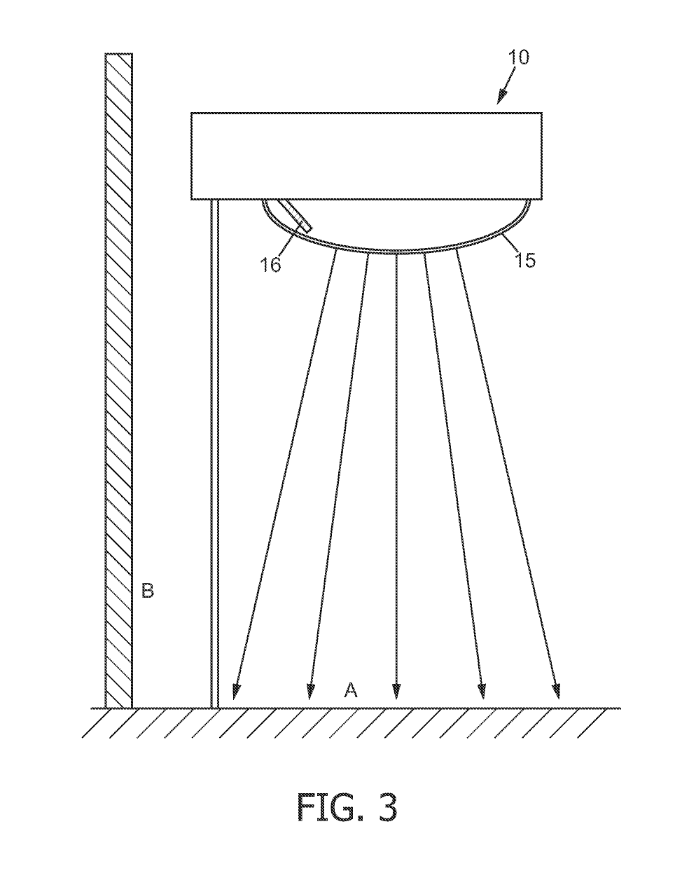

Operation of the luminaire will now be described with reference to FIGS. 2 and 3. A target illumination area is represented by A and extends from a region below the luminaire to a region in front of the luminaire beyond the scope of the Figure. The region outside the target area where it is desired that light should not trespass is represented by façade B which in this embodiment is located behind the luminaire 10. Other regions which may need protection from light trespass may include walls, buildings or certain pedestrian walkways. In use, light is directed through the light exit portion 15 from the light source 12 towards a target region A remote from the luminaire assembly 10.

Track (a) represented by the dotted line represents light being emitted from the light source 12 in a direction extending towards façade B. The light on track (a) is intercepted by the reflector element 16 before exiting enclosure 13 through exit portion 15. The light is then deflected by light reflector 16 onto a path extending through the exit portion 15 in a direction different to its initial incident direction. The light then exits enclosure 13 through light exit portion 15 in a direction towards the desired illumination region A.

Track (b) represented by the dashed line, represents light emitted from the light source 12 in a direction towards the top of the enclosure 13. The light hits reflective layer 14 where it is reflected onto a path heading towards the rear region of the luminaire 10 extending towards façade B. Before exiting enclosure 13 through light exit portion 15 the light on track (b) is intercepted by light reflector 16 which redirects the light from its initial path onto another path extending through the light exit portion 15 in a different direction. The light then exits the enclosure 13 through light exit portion 15 in a direction towards the desired illumination region A.

Track (c) represented by the double dot-dashed line, represents light emitted from source 12 in a direction towards the top of the enclosure 13. The light hits reflective layer 14 where it is reflected onto a path heading towards the desired illumination region A via light exit portion 15. In this case interception and redirection of the light is not required since the light is heading along a path extending towards the desired illumination region A.

Track (d) represented by the single dot-dashed line represents lights emitted from light source 12 in a direction extending towards façade B, before exiting light exit portion 15 the light is intercepted by reflector 16. The light is then reflected by reflector 26 onto a path in a direction different to its incident direction. In this case the light is redirected within enclosure 13 towards reflective layer 14 which then reflects the light along a path extending through light exit portion 15 in a different direction to the initial direction, towards the target illumination region A. The light exits enclosure 13 through light exit portion 15 towards the target illumination region A.

Tracks (e) and (f) represent light emitted from light source 12 towards desired illumination region A. No redirection of the light is required in these cases and so the light passes directly to the desired illumination region A without having its direction modified by the lighting assembly 10.

Light reaching façade B is thereby reduced. Moreover since the light which would otherwise have been heading towards façade B is redirected towards the target illumination region A, less light is wasted and luminaire spacing does not need to be reduced, and may even be increased. This leads to a more economical lighting system.

In this embodiment, the reflector 16 may be removed if light is required to reach a region behind the luminaire, for example to light up a pedestrian walkway. The luminaire assembly is provided with fixation means in order to attach the reflector 16 to the luminaire 10. The size and shape of the reflector 16 may be adjusted according to the lighting needs or the configuration of the luminaire. The simplified structure of the reflector requires little tooling and its low cost make it an attractive solution. Since the reflector 16 is located within enclosure 13 the reflector is less exposed to external environmental conditions and its lifetime is extended, thereby facilitating maintenance. Moreover disposing the reflector 16 within the enclosure 13 makes the luminaire more aesthetically pleasing. Furthermore, since the reflector 16 is located in the lower region of the luminaire 10 access to the reflector is facilitated for maintenance and the function of the upper reflector 14 is not modified or interfered with.

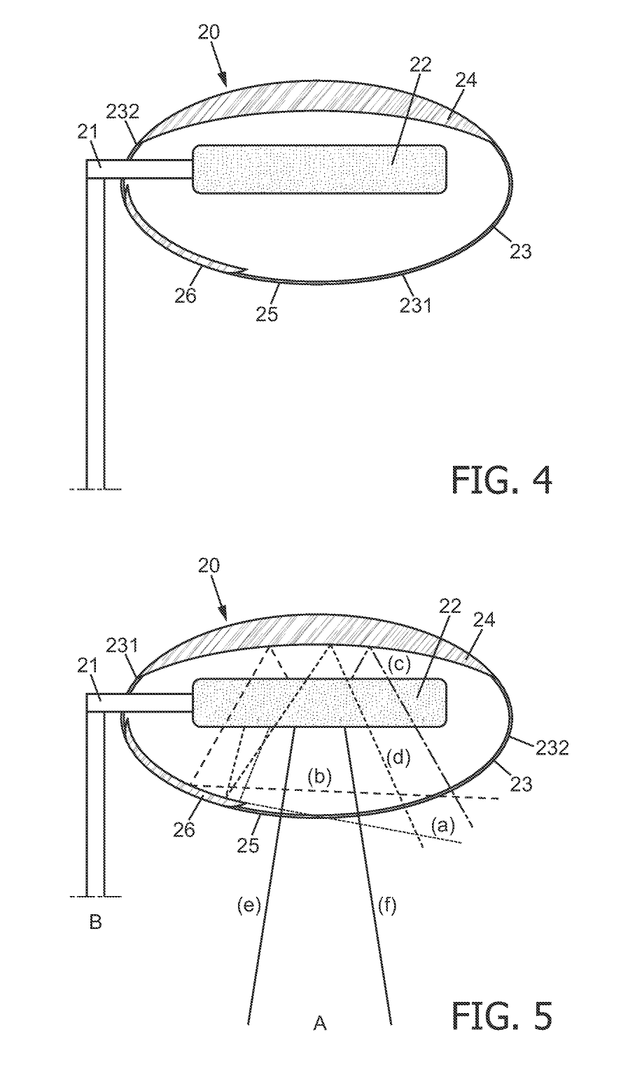

A road lighting luminaire according to a second embodiment of the invention will now be described with reference to FIGS. 4 to 6.

The road lighting luminaire 20 of the second embodiment is similar to the first embodiment and like features are allocated the references numerals of FIG. 1 plus 10. In this embodiment, however, instead of including a separate removable reflector, a portion of the inner surface of the light exit portion 25, in the rear region of the lower portion 231 of the housing 23, is provided with a layer of reflective coating 26 orientated to face towards light source 22 to act as a light intercepting element. The coating may be provided by, for example, applying a spray reflective paint or a metallisation process.

While in this embodiment, the light reflecting coating 26 is provided on the inner surface of the lower portion 231 of the housing 23, it will be appreciated that in alternative embodiments a layer of light reflecting paint or coating may be provided on the exterior surface of lower portion 231 of the housing 23 but facing towards light source 22 such that light is prevented from exiting the housing along paths extending from the housing towards a region outside the region to be illuminated. Locating the layer of coating on the inner surface is preferable since it will be less exposed to environmental conditions enabling it to last longer and to be maintained more easily.

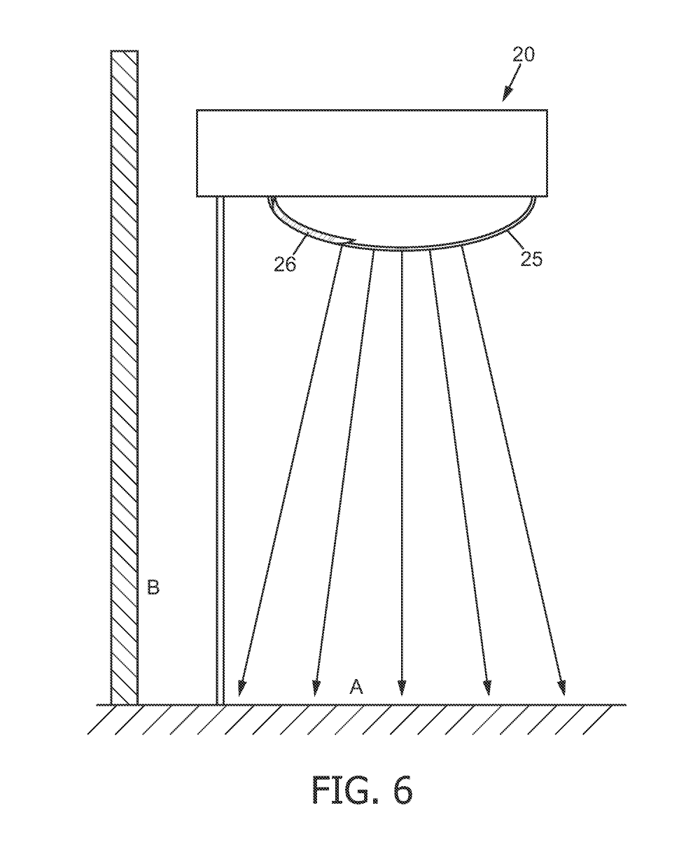

Operation of the luminaire will now be described with reference to FIGS. 5 and 6. In use, light is directed through the light exit portion 25 from the light source 22 towards a target region A remote from the light assembly 20.

Track (a) represented by the dotted line represents light being emitted from the light source 22 in a direction extending towards façade B. The light on track (a) is intercepted by reflective layer 26 before exiting enclosure 23 through light exit portion 25. The light is then reflected onto a path extending through light exit portion 25 in a direction different to its initial direction. The light then exits enclosure 23 through transmission medium 25 in a direction extending towards the desired illumination region A.

Track (b) represented by the dashed line, represents light emitted from the light source 22 in a direction towards the top of the enclosure 23. The light hits reflective layer 24 where it is redirected on a path heading towards façade B. Before exiting enclosure 23 through transmission surface 25 the light on track (b) is intercepted by reflective coating layer 26 which redirects the light from its incident path onto another path extending in a different direction. The light then exits enclosure 23 through transmission medium 25 in a direction towards the desired illumination region A.

Track (c) represented by the dot-dashed line, represents light emitted from source 22 in a direction towards the top of the enclosure 23. The light hits reflective layer 24 where it is reflected onto a path heading towards the desired illumination region A via light exit portion 25. In this case redirection of the light is not required since the light is heading towards the desired illumination region.

Track (d) represented by shorted dashed line represents lights emitted from light source 22 in a direction extending towards façade B, before exiting light exit portion 25 the light is intercepted by reflective coating layer 26. The light is then reflected by reflective coating layer 26 onto a path in a direction different to its incident direction. In this case the light is redirected within enclosure 23 towards reflective layer 24 which then reflects the light along a path extending through light exit portion 25 in a different direction to the initial direction. The light exits enclosure 23 through light exit portion 25 towards the target illumination region A.

Tracks (e) and (f) represent light emitted from light source 22 towards target illumination region A. No redirection of the light is required in these cases and so the light passes directly to the desired illumination region A without having its direction modified by the lighting assembly 20.

Light reaching façade B is thereby reduced. Moreover since the light which would otherwise be heading towards façade B is redirected towards the target illumination region A, less light is wasted and luminaire spacing does not need to be reduced, and may even be increased, in some cases from 5-20%. This leads to a more economical lighting system.

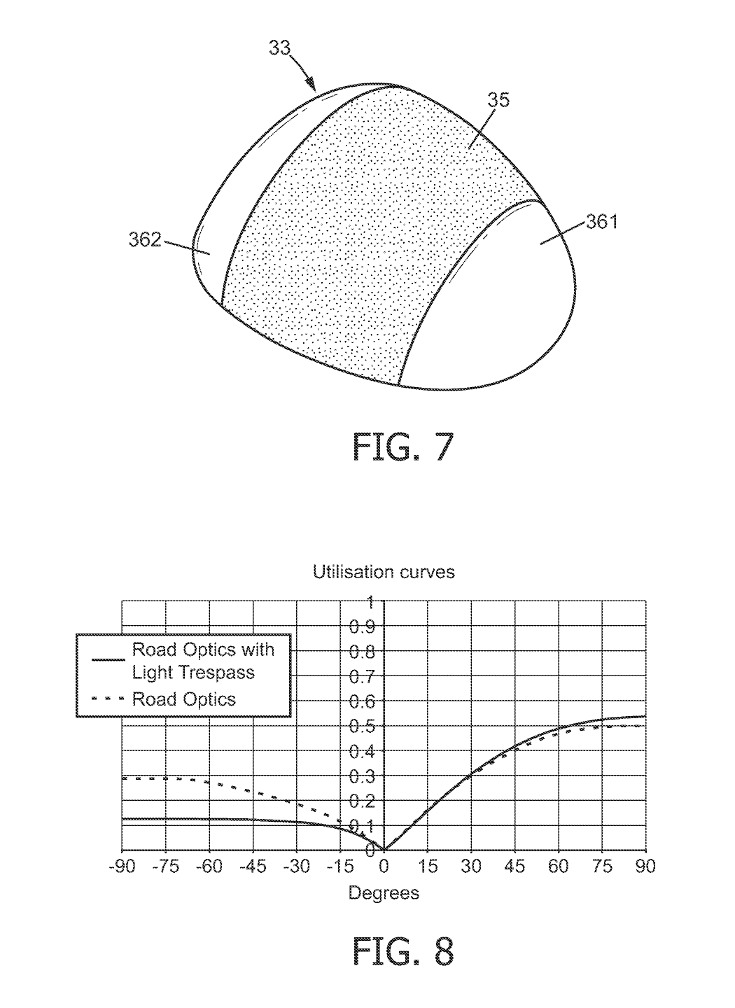

An alternative embodiment of the invention is depicted in FIG. 7. This embodiment of the invention is similar to the second embodiment of the invention. FIG. 7 illustrates a lower portion 331 of housing 33 showing the light exit portion 35. Two separate reflective coating portions 361 and 362 are provided on the inner surface of lower portion 331 of the housing at the rear side and the front side respectively of the housing 33 on either side of light exit portion 35. In use light incident on reflective coating portions 361 and 362 are redirected onto paths extending through light exit portion 35 towards the target illumination area.

FIG. 8 depicts the results of using the embodiments of the invention. In FIG. 8 light flux reaching a desired illumination region such as a road is represented by positive angles while light reaching behind the luminaire to a non-targeted area is represented by negative angles. The continuous line represents the results when embodiments of the invention are employed to reduce trespassing light—the flux reaching behind the luminaire is reduced compared to a luminaire without such a light deflecting element, while the light flux reaching the road is increased.

Embodiments of the invention find applications in road lighting and other outdoor lighting applications. It will be appreciated that the embodiments of the invention may also find applications in indoor application where it is desirable to reduce light trespass.

Although the present invention has been described hereinabove with reference to specific embodiments, the present invention is not limited to the specific embodiments.

For example although in the foregoing embodiments the light intercepting surface is reflective it will be appreciated that in alternative embodiments the light intercepting surface may absorb the light to prevent it from reaching the area outside the target illumination area. In other embodiments the intercepting element may comprise other types of light deflecting materials.

Many further modifications and variations will suggest themselves to those versed in the art upon making reference to the foregoing illustrative embodiments, which are given by way of example only and which are not intended to limit the scope of the invention, that being determined solely by the appended claims. In particular different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A luminaire assembly comprising:
a support for receiving a light source;
a housing including a light exit portion through which light from the said light source exits the housing, the light exit portion being disposed between a said light source and a target area to be illuminated;
a light intercepting element for preventing light from exiting the light exit portion along paths extending from the light exit portion in directions towards a region outside the target area.

2. A luminaire assembly according to claim 1, wherein the light intercepting element is arranged to redirect at least part of the light, according to said paths, in such a manner that said at least part of the light reaches the target area.

3. A luminaire assembly according to claim 1, wherein the light intercepting element comprises a removable reflector element.

4. A luminaire assembly according to claim 1, wherein the light exit portion comprises a light exit element at least partly transparent to the light and wherein the light intercepting element comprises a reflective layer provided on an inner and/or outer surface of the light exit element.

5. A luminaire assembly according to claim 1, wherein the light intercepting element is adjustable to redirect light in a plurality of different directions.

6. A luminaire assembly according to claim 1, wherein the light exit portion is bowl shaped.

7. A luminaire assembly according to claim 1, wherein the light intercepting element is disposed within the housing between the said light source and the light exit portion.

8. A luminaire assembly according to claim 1, further comprising a back reflector arranged to redirect light travelling in a direction away from the light exit portion towards the light exit portion.

9. A luminaire assembly according to claim 8 wherein the intercepting element is arranged to redirect at least part of the light from said paths towards the back reflector.

10. A luminaire assembly according to claim 2, wherein the intercepting element is arranged to redirect at least part of light from said paths to second paths extending in second directions towards the target area.

11. A luminaire assembly according to claim 1, comprising a plurality of light intercepting elements.

12. (canceled)
